(19) United States
(12) Patent Application Publication
(10) Pub. No.: US 2003/0225572 A1
(43) Pub. Date: Dec. 4, 2003

(54) Selectively attachable device for electronic annotation and methods therefor

(76) Inventors: Guy de Warrenne Bruce Adams, Stroud Gloucestershire (GB); David Mark Frohlich, Bristol (GB); Malcom Rix, San Diego, CA (US); John Deryk Waters, Bath (GB)

Correspondence Address: HEWLETT-PACKARD COMPANY, Intellectual Property Administration, P.O. Box 272400, Fort Collins, CO, 80527-2400, US

(21) Appl. No.: 10/390,960

(22) Filed: Mar. 18, 2003

Related U.S. Application Data
(63) Continuation-in-part of application No. 09/719,150, filed on Dec. 8, 2000, now abandoned.
Application No. 09/719,150 is a 371 of international application No. PCT/GB99/02194, filed on Jul. 8, 1999.

(30) Foreign Application Priority Data
Jul. 8, 1998 (EP) 98305436.2

(51) Int. Cl. G10L 19/14; G10L 19/00

(52) U.S. Cl. 704/201; 704/225

(57) ABSTRACT

An annotation is recorded on to an electronic storage medium for inclusion within a storage device which is selectively engageable with an arbitrary physical object. This engagement can be provided by a number of conventional means: a spring loaded clip (particularly suitable for engagement with objects), a weakly adhesive surface, or a magnetic element. The annotation may then be read from the sound storage device while it remains engaged with such an arbitrary object using an appropriate further device. This arrangement is particularly appropriate for annotation of documents with sound, and thus allows sound passages to be used in a very versatile fashion, particularly for annotation and messaging.

### FIELD OF THE INVENTION

The present invention relates to methods and apparatus for electronic annotation. Aspects of the present invention are particularly relevant to use of recorded sound, and particularly for attaching recorded sound to physical objects.

### DISCUSSION OF PRIOR ART

A large number of methods of recording sound, and sound recording media, exist. However, although sound has many advantages which other forms of communication and content provision do not have (particularly personality and immediacy), it is currently difficult to use recorded sound in a versatile, general purpose way in relation to arbitrary objects. In particular, it is difficult to use recorded sound in connection with objects and media customarily found in the home or office (papers, work surfaces etc.) in a cheap, immediate and effective manner.

Numerous types of printed document are known which contain stored sound and sound reproduction apparatus to reproduce this stored sound—examples are found in U.S. Pat. Nos. 5,710,422, 5,480,156, 5,671,555, 5,063,698 and 6,282,819. A picture frame containing stored sound and sound reproduction apparatus is described in U.S. Pat. No. 5,359,374. None of these appears to provide any solution to the more general problem of annotation of an existing document with sound.

### SUMMARY OF INVENTION

Accordingly, the invention provides a sound storage device for annotating an arbitrary object with a passage of sound comprising: an electronic storage device adapted to store information defining a passage of sound; a body on which, or in which, the electronic storage device is arranged; and an attachment mechanism to enable selective engagement between the body and an arbitrary object of a type suitable for engagement with the attachment mechanism; the sound storage device having within it no means for playing back the passage of sound, but being adapted such that the information defining a passage of sound may be accessed from the device throughout the time of engagement between the body and such an arbitrary object by a sound reproduction device adapted to convert said information received from the electronic storage device into the passage of sound.

This arrangement is particularly advantageous, as it allows for simple addition of sound to arbitrary objects which can then be read very simply with an appropriate reproduction device, while leaving the association between the sound and the object intact until it is desired to remove it. This is clearly advantageous for situations such as messaging in an office environment. Such devices can thus usefully be re-recorded when the original passage of sound is no longer required, reducing the overall cost of use.

The attachment mechanism may be chosen for suitable classes of arbitrary object. One option is for the mechanism to be a spring clip—this is particularly suitable for attachment to paper documents. Alternatives are adhesive surfaces (suitable for attachment to objects with a surface to which the adhesive surface weakly adheres) or a magnetic element (suitable for objects attracted to the magnetic element).

Further advantages can be found if the sound storage device is adapted also to retain information of other types, such as an image, an archive reference, or information relevant to the capture of the passage of sound. This is particularly useful if sound reproduction devices are available which are also able to consume or otherwise use such further information.

A variety of electronic storage devices are available—a particularly suitable choice is an integrated circuit. Contact to devices which can read or write to the electronic storage device can be made by appropriate electrical contacts, exposed for access when the engagement mechanism is in operation—the electronic storage device (and the sound storage device) may also be powered in this way. Alternatively, the electronic storage device may be powered inductively, and written to or read from by modulation of the powering signal or its reflection.

In a further aspect, the invention provides a sound recording and playback system, comprising: a sound storage device as described above; a sound recording device adapted to record a passage of sound on to the sound storage device; and a sound reproduction device adapted to obtain the information defining the passage of sound from the sound storage device, to convert said information received from the electronic storage device into the passage of sound, and to reproduce the passage of sound.

It may be a particularly advantageous arrangement for the sound recording device and the sound reproduction device to be the same (for example, a dictation device).

In a further aspect, the invention provides a method of temporarily annotating arbitrary objects with sound, comprising: storing information defining a passage of sound in a sound storage device which comprises an electronic storage device but which does not comprise any means for playing back the passage of sound; attaching the sound storage device to the arbitrary object such that information defining the passage of sound may be accessed through interaction with an appropriate sound reproduction device; removing the sound storage device from the arbitrary object; and attaching the sound storage device to a further arbitrary object such that information defined by a stored passage of sound may be played back by interaction with an appropriate sound reproduction device.

In a further aspect, the invention provides a method of annotating arbitrary objects and providing annotations to a user, comprising the steps of: storing an annotation in a storage device which comprises an electronic storage device but which does not comprise any means for enabling the annotation to be directly perceived by a user, the storage device having an antenna to couple power inductively into the storage device, having a wireless transmitter circuit and having a wireless receiver circuit; attaching the storage device to the arbitrary object such that the annotation may be transmitted from the storage device by the wireless transmitter circuit when the storage device is inductively powered through the antenna for receipt by apparatus adapted to provide the annotation for direct perception by the user; and adding a further annotation to the storage device by coupling power inductively into the storage device through the antenna and transmitting the further annotation to the wireless receiver circuit for storage in the electronic storage device.

In a further aspect, the invention provides a storage device for annotating an arbitrary object comprising: an electronic storage device adapted to store an annotation; an antenna adapted to couple power inductively into the storage device; wireless transmitter and receiver circuitry adapted such that when powered, the storage device can wirelessly receive data for and transmit data from the electronic storage device; a body on which, or in which, the electronic storage device is arranged; and an attachment mechanism to enable selective engagement between the body and an arbitrary object of a type suitable for engagement with the attachment mechanism; the storage device being adapted such throughout a time of engagement between the body and such an arbitrary object when the antenna couples sufficient power into the sound storage device, the annotation may be wirelessly transmitted from the storage device and a further annotation may be wirelessly received by the storage device for storage in the electronic storage device.

In a further aspect, the invention provides a method of annotating arbitrary objects and providing annotations to a user, comprising the steps of: storing an annotation in a storage device which comprises an electronic storage device but which does not comprise any means for enabling the annotation to be directly perceived by a user, the storage device having electrical contacts for engagement with a further device to allow connection between the further device and the electronic storage device so that the further device may power the storage device and that when powered, the storage device can receive data for the electronic storage device from the further device and transmit data to the further device from the electronic storage device; attaching the storage device to the arbitrary object such that the electrical contacts are engageable with the furthe device; engaging the electrical contacts with the further device and reading the annotation from the electronic storage device into the further device, wherein the further device is adapted to provide the annotation in a form susceptible of direct perception by the user; and engaging the electrical contacts with the or another further device and adding a further annotation to the storage device by transmitting the further annotation from the or another further device to the storage device for storage in the electronic storage device.

### DESCRIPTION OF DRAWINGS

Embodiments of the invention are described further below, by way of example, with reference to the accompanying drawings, in which:

FIG. 1 shows the elements involved with recording of sound for use in accordance with embodiments of the invention, and those involved with use of the recorded sound by a user;

FIG. 2 shows an electronic storage device for use in embodiments of the invention;

FIGS. 3A and 3B show in plan view and side elevation respectively the mounting of an electronic storage device on to a flexible substrate to provide a device in a form suitable for use in a removably attachable clip;

FIG. 4 shows schematically the components required to write a passage of sound into, or play it back from, an electronic storage medium adapted to hold a passage of sound as a digital signal in an example of a system as shown in FIG. 1;

FIG. 5 shows schematically the components required to write a passage of sound into, or play it back from, an electronic storage medium adapted to hold a passage of sound as an analog signal in an example of a system as shown in FIG. 1;

FIG. 6 shows a sound reproduction device for reproducing a passage of sound held on an electronic storage medium suitable for use in the system of FIG. 1; and

FIG. 7 shows the elements of a sound recording system usable in the context of the invention;

FIGS. 8A, 8B and 8C show examples of clips suitable to include the electronic storage device of FIG. 2 and which are removably attachable to printed images in accordance with embodiments of the invention: FIG. 8A shows a spring clip; FIG. 8B shows a weakly adhesive clip and FIG. 8C shows a magnetic clip;

FIG. 9 shows a further form of electronic storage device and reader in accordance with a further aspect and further embodiments of the invention;

FIG. 10 shows schematically the functional elements of the electronic storage device of FIG. 9;

FIG. 11 shows schematically the components required to write a passage of sound into, or play it back from, an electronic storage medium adapted to hold a passage of sound as a digital signal in an example of a system as shown in FIG. 9; and

FIG. 12 shows the mechanical and process elements of a clip recording device as shown in FIG. 1.

### SPECIFIC DESCRIPTION OF PREFERRED EMBODIMENTS

Although most discussion that follows relates explicitly to sound clips and to devices and elements described in relation to sound recording, as will be noted below the system is functionally suitable for other forms of annotation as well as, or even instead of, sound.

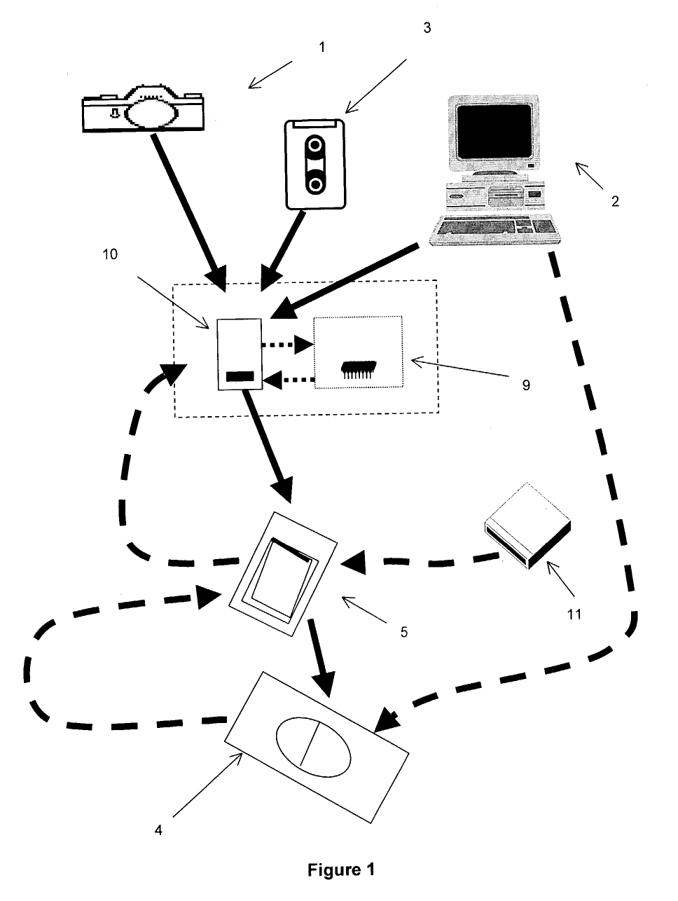

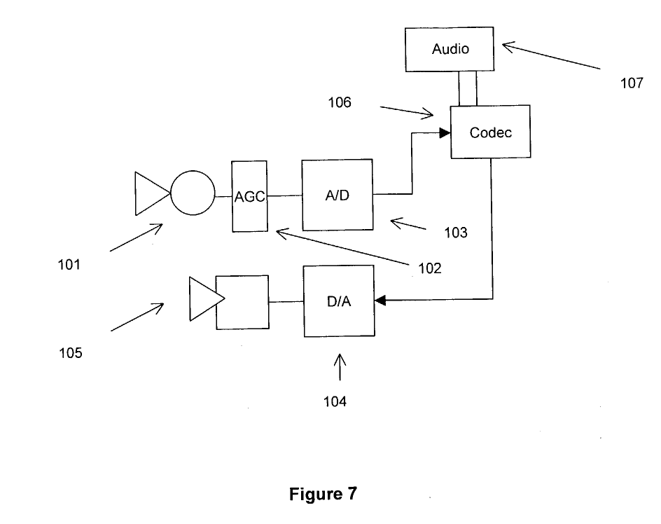

Basic components in a system for provision, and use, of sound clips for attachment to arbitrary objects are shown in FIG. 1. The sound capture device may be any of the conventional alternatives for sound capture, such as a dictation device 3, or a personal computer 2 with microphone, or even a device such as a camera 1. There are a multitude of alternative capture devices (telephone answering machines, tape or disk recorders, etc)—essentially any form of device for capturing a passage of sound can be used. The basic elements of a sound capture device are as shown in FIG. 7: a microphone 101 and an automatic gain controller 102 (in digital embodiments, such as is specifically shown in FIG. 1, an analog/digital converter 103 and a codec 106 are also required)—where playback is also available, a loudspeaker 105 (and, if digital, a digital/analog converter 104) must also be provided. Typically a memory 107 for storage of audio and image information will also be required.

This process of sound capture may be analog, on to an analog sound recording medium Alternatively, and preferably, sound capture may be digital, with sound stored in an appropriate storage medium (for example, on an Iomega “Clik” disk (“Clik” is a trade mark of Iomega Corporation) or on a Sandisk “Compactflash” storage device (“Compactflash” is a trade mark of Sandisk). In this event, the digital data can be provided to a digital processing means (such as personal computer 2). This is advantageous, as it allows for easy editing of sound data.

The created sound then needs to be sent (possibly after editing on personal computer 2 or elsewhere) to a clip recording device 10. This clip recording device 10 may itself have processing capacity (with the possibility of editing or reviewing sound clips) or it may be attached to (perhaps as a peripheral to) a processing device 9 with this capacity (perhaps again a personal computer—maybe the same as through which sound was captured). This clip recording device 10 could perhaps be integrated with another type of media device (such as a document printer)—as will be discussed below, it is also logical for the function of a clip recording device 10 to be present in a sound reproduction device 4 used to play sound from the clip.

Different kinds of clip 5 can then be provided (either with a single clip recording device 10 or by a series of alternative clip recording devices 10, according to design), for connection with different objects. The requirements of the clip 5 are that it contains an electronic storage device, but also that it has an attachment mechanism to enable selective engagement between the body and an arbitrary object of a type suitable for engagement with the attachment mechanism (in essence, that it can engage with any object for which the form factor of the attachment mechanism is suitable) and moreover so that the passage of sound can be read out from the device while it is still engaged to an object. The clip can be provided in a number of different form factors, as will be discussed below.

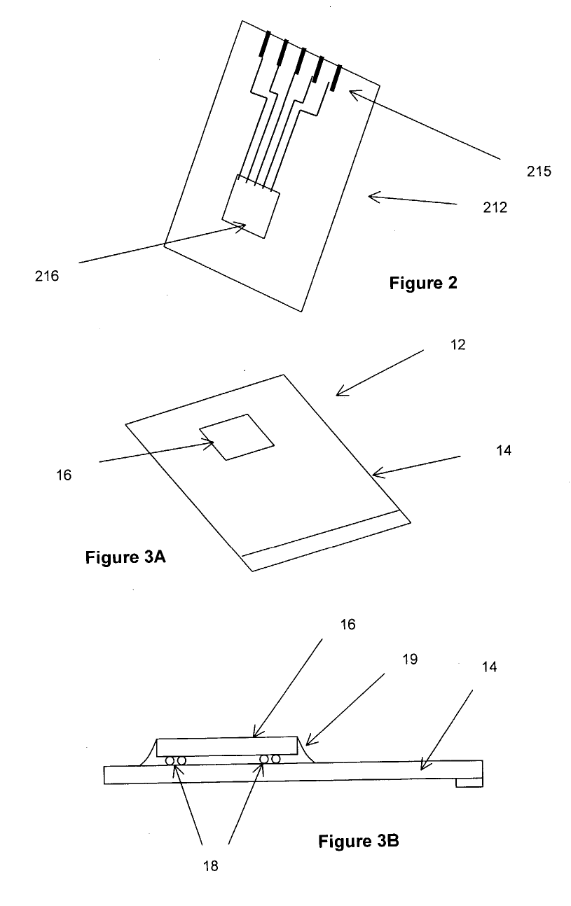

A key element in the clip is an electronic storage device 212, which is used for storage of the passage of sound. Such a device is shown in more detail in FIG. 2. It comprises a die 216 containing a memory (which may be for example a flash memory, or another form of EEPROM or PROM) in which the passage of sound is recorded, the die 216 being connected by tracks to connectors 215. The die 216, the tracks and the connectors 215 are all mounted on an appropriate substrate. Design and function of the electronic storage device is discussed further below.

For the clip to be played, a sound reproduction device 4 is employed. This can be connected to the electronic storage device (the electronic storage device is advantageously positioned within the clip such that this is possible without removing the clip from its engagement with any physical object) to enable information stored in the electronic storage device to be transferred to the sound reproduction device 4, the sound reproduction device 4 containing means to convert the information received from the electronic storage device into the passage of sound. Sound reproduction device 4 is adapted to be detachable or otherwise remote from the clip when no connection between the electronic storage device and the sound reproduction device 4 is required.

As is shown by the dotted lines on FIG. 1, a system without a dedicated clip recording device 10 is quite possible. The most logical alternative solution is for the sound reproduction device 4 to be provided with the capability to write as well as read recorded sound, and for clips to be recorded at the sound reproduction device 4. However, any system component (particularly those which already include capacity for sound reproduction) may in principle be adapted to have the capacity to write sound on to clips.

Other elements may be provided in this system. A useful further such device is a storage applicance 11, which is adapted to both read and write passages of sound to and from clips, and which is also adapted to hold a large number of passages of sound, preferably in an indexed archive for convenient retrieval.

As the person skilled in the art will appreciate, the system of FIG. 1 could be expanded or modified by use of different components with different or expanded functionality, or by appropriate communication mechanisms between the components. Any component with appropriate functionality for capture, writing or playback of sound could in potential be used, as could any component type that could be effectively modified for such a purpose or to include such a purpose along with its existing functionality. If appropriate communication mechanisms were present, any appropriate communication type or path could be used between appropriate system components.

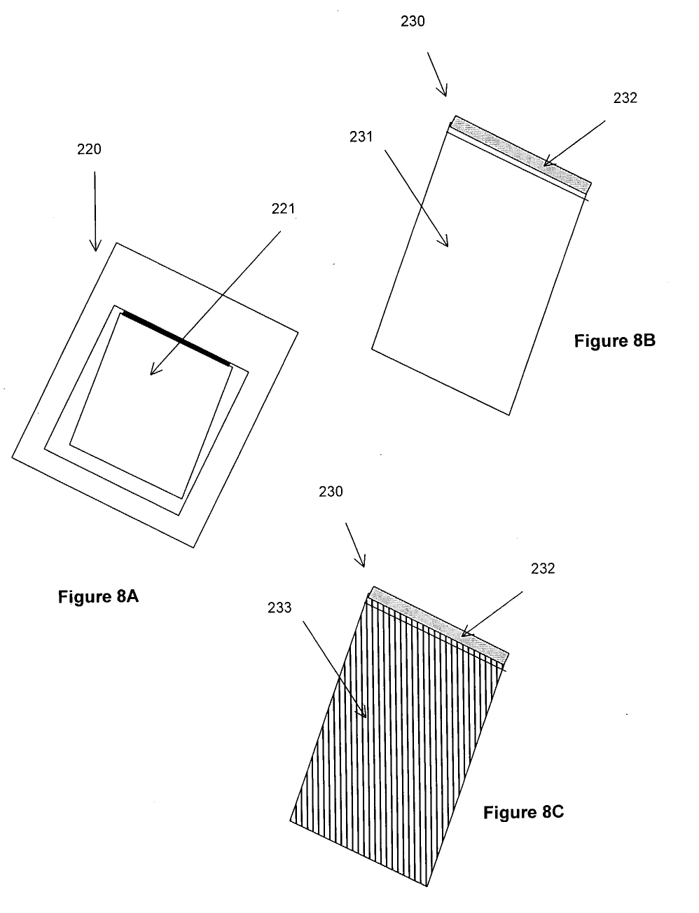

A variety of attachment types are suitable for use within these constraints, as is shown in FIGS. 8A to 8C. A spring clip may be used for connection to documents, as is shown by clip 220 in FIG. 8A. This has a conventional paperclip design, with a storage device as shown in FIG. 2 to be placed on the rear face of central leg 221 of the clip 220. An adhesive clip, analagous to the Post-It Note of 3M, is shown in FIG. 8B. In this design, the storage device is placed on the rear face of tab 230, of which the front face 231 comprises adhesive material (preferably weakly adhesive, to allow re-use) and an alignment ridge 232 is provided to allow accurate location of a document edge. A magnetic clip, broadly similar to the adhesive clip, is shown in FIG. 8C—it resembles the weakly adhesive clip shown in FIG. 8B, differing in that front face 233 is now magnetic, rather than weakly adhesive.

In such arrangements, the sound information now need have no association with a specific image, but may be attached instead to a document—for example, as a note providing a brief summary of a document, or giving instructions as to how it should be handled or processed.

It will in many modes of use be advantageous for clips to be reusable—that is, arranged such that they can be returned to clip recording device 10 and re-recorded.

The form factor employed for a clip would be appropriate to the intended use: for use with documents, the form factor could be that of a more or less conventional paperclip design such as clip 220, or a sheet of paper held with a weakly bonding glue such as tab 230: whereas for use with other objects, the electronic storage device could be provided on a magnetic base (for use as a fridge magnet, for example). As the skilled man will appreciate, a variety of form factors are available possessing the common feature of removable attachment to a target object. The formation and recording of clips will be discussed further in connection with the clip recording device 10.

The information recorded on electronic storage device 12 may be more than a simple passage of sound: additional information such as time of recording or even a related image, video or data file may be added. Clearly, this is particularly appropriate where sound is stored digitally on electronic storage device 12. Such information could be entered and recorded at the sound capture device (this may include information such as the time of recording) or may contain extensive annotation or other information provided at personal computer 2, sound reproduction device 4, or elsewhere: such information may be provided as a text file, or in an appropriate file format. Examples of particular additional information, and the consequent advantages, will now be discussed.

One possibility is for the electronic storage device to contain an image (perhaps as a GIF file) to which the sound passage relates. This image could be provided as a full representation of an original image (to allow it to be recreated) but could also be provided as a thumbnail for use as a low cost method of identifying the sound clip. A series of images could be provided, or even a video clip (perhaps a video clip to which the passage of sound was an appropriate reference). Provision of such additional information can make it advantageous for the sound reproduction device 4 to also contain a display (not shown). This display may be adapted to show some or all of the additional information recorded in the memory, possibly including a representation of images (or video) stored.

Location of capture could be recorded in such further information: either by user input, or conceivably by means of a GPS receiver or similar location sensing means within the camera itself. Audio settings could be recorded similarly, and in many cases by an appropriate manner of recording information produced automatically by the capture device. User annotation could also be provided in the capture device.

Other information types that could be provided would more typically be added in processing of an image at personal computer 2. A particularly useful indication is a reference to an archive (such an archive reference might be in the form of a web URL, a personal computer directory, or a flash card number). Other information added could be information to assist in searching, such as classification of the audio by type (for example, speech or ambient sound), or simply to identify relevant or associated material (again, a web URL on the public internet for a site associated with the captured element). Other information typically added at the personal computer point could be related to security, or other forms of control (for copyright licensing purposes, for example)—such information could be a total number of copies of the data allowed, or text information indicating the copyright owner. The sound reproduction device 4 would again be an appropriate place to add information, particularly annotation by the user.

It will be appreciated from the discussion above that this model of annotation of a document, or other object, by content stored in an electronic storage device removably attached to the document (or other object) is not necessarily limited to annotation by sound. A document can thus be annotated by one or more of the types of additional data discussed above instead of, rather than merely as well as, being annotated by sound. While annotation by sound is considered to be particularly valuable, a number of circumstances can be imagined when documents or other physical objects might be annotated with electronically stored text or video, for example. Removably attachable clips holding electronic content accessible to an appropriate reader can clearly be used for annotation by text or video (and potentially by other forms of electronic content) as well as by sound, and the possibility of rewriting as well as reading such content makes new models of annotation both technically possible and economically feasible.

Further description of particular embodiments of the electronic storage device, the clip recording device, and of the sound reproduction device are provided below.

The construction of a particularly suitable electronic storage device, here termed an audiotab, is shown in FIG. 3A. Die 16 contains a memory device—advantageously a flash memory or other non-volatile EEPROM, though another form of PROM could provide a suitable alternative. As shown in FIG. 3b, die 16 is fixed to a substrate 14 by a number of solder bumps 18 to establish electrical connection between the die 16 and the conducting tracks on the substrate 14, and an insulating material is provided as a fill 19 to bind the die 16 into a common structure with the substrate 14. The substrate 14 is then mounted in or on an appropriate clip body. This aspect is described further with respect to the chip recording device. In some cases (such as in the case of a clip which is to be attached to documents, particularly where the attachment mechanism is by a weakly adhesive surface), it is desirable for the substrate 14 to be flexible, and in some cases of at least comparable flexibility to a document, otherwise the chance of the electronic storage device becoming detached increases significantly and the clip and document combination will become more difficult to handle.

In the embodiment shown, connections to the audiotab are made by contact with a device (generally the sound reproduction device) abutting the edge of the printed image 11 in some way. Other forms of connection are quite possible. For example, connection could be made by surface contact, rather than by an edge connection of this type. Alternatively, signals and power could be transmitted without direct contact (signals by a variety of means, power typically by induction) as is described in more detail below. It should also be noted that although connections to the audiotab for both signal and power are provided together (in preferred embodiments the audiotab will have no source of power itself, but will draw power from a device accessing it), this is not a necessary feature of the invention, and the two could be provided through different connectors, for example.

Also possible are different types of audiotab construction. For example, it may be possible to print appropriate circuitry directly on to an appropriate substrate material, removing the need for a chip (and hence for the mounting of the chip on to the substrate).

The clip recording device 10 and its use will now be further described.

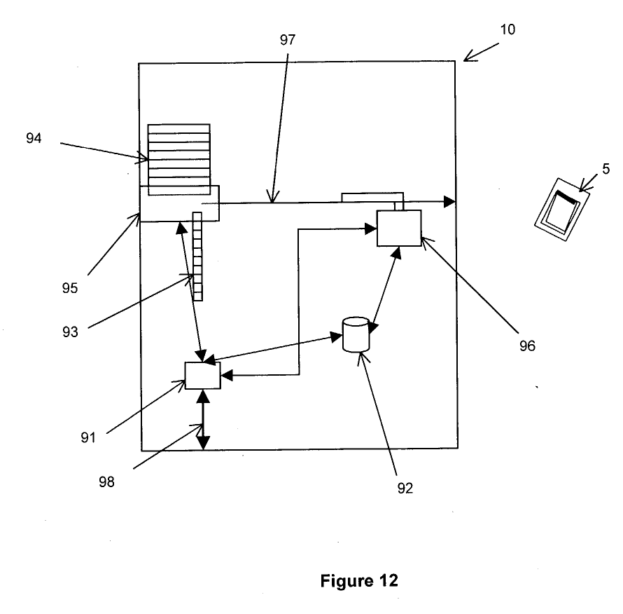

The essential function of this device is to download a passage of sound into an electronic storage device, and to provide as an output a recorded clip as described. As the person skilled in the art will be aware, there are a number of ways in which this can be realised. Mechanically complete clips may be provided at the device to be recorded with sound. Alternatively, if mechanically advantageous at the clip recording device, electronic storage devices on substrates may be first recorded, and then integrated with a particular clip body (or first integrated and then recorded). This may be a preferred choice where the clip recording device is pre-loadable with a number of electronic storage devices for recording, and particularly where the clip recording device itself is adapted to use more than one kind of clip body (and hence provide more than one kind of clip—for example, it is adapted to provide either spring loaded clips or weakly adhesive clips). Such an arrangement is shown in FIG. 12. A first reservoir 93 of electronic storage devices and a second reservoir 94 of clip bodies is provided, and when a clip is to be recorded a storage device from the first reservoir is bonded to a clip body from the second reservoir under control of clip recording device processor 91—instructions to create a clip, and to identify the data to be used in the clip, would be provided either by data from a separate device (such as PC 2 in FIG. 1) or by a user interface, not shown, interacting with processor 91. Clearly, such a bonding step is only useful if there are in fact a number of second reservoirs mounted, for example, on a carousel so that a particular type of clip body can be selected. The bonded audioclip can then be conveyed by an appropriate mechanism (for which many conventional arrangements are possible—conveyance is shown simply by arrow 97 in this case) to a recording station 96 (the details of which are described further below in respect of the functional elements of reading from and writing to the electronic storage device) again under the control of processor 91. Data for recording, which will generally have been received from a device external to the clip recording device (a data path 98 into and out of the processor 91 is shown) and stored in a memory 92 of the clip recording device, is provided to the recording station 96, the audioclip recorded and conveyed out in the form of completed audioclip 5, ready for attachment to a document.

Mechanically, the clips themselves may be simple devices, designed for their intended use, and manufactured in a conventional manner. If the clips are preassembled prior to recording, techniques such as overmoulding may be used (suitable for the spring clip type) or the substrates on which the electronic storage devices are mounted may simply be bonded to a conventional clip (or magnet, or adhesive surface) structure with an appropriate bond (adhesive, solder and welding are all possibilities available with appropriate structures). Alternatively, in cases where the clips are not assembled until after recording, a bonding element of some kind is provided within the clip recording device (where bonding here may include mechanically manipulating a clip body relative to a mounted electronic storage device to lock the electronic storage device into engagement with the clip body).

Where a stack of blank clips, or electronic storage devices (with separate clip bodies) is provided in the chip recording device 10, appropriate automatic handling mechanisms can readily be provided by consideration of analagous art. Blank clips or devices could be provided in a cartridge form, or on a bandolier. The bandolier solution may be particularly appropriate for blank electronic storage devices, as these could then be made self adhesive and after recording could be detached from the bandolier and the adhesive agent used to provide or contribute to the engagement between the electronic storage device and the clip body. Appropriate automatic handling would preferably be provided for the clip bodies also. Where alternative clip bodies could be provided, it would be desirable for these to be designed so that each was adapted to carry the same type of mounted electronic storage device, and so that a minimum of user action was required to change between recording one type of clip to recording another.

The clip recording device 10 can be provided as a separate component of the system. However, it may be advantageous for the clip recording device to be provided as a peripheral to a processing device (possibly personal computer 2 or another personal computer), to allow easier user control and greater flexibility of use. Another appropriate solution is for the clip recording device to be included within another device of different functionality. A suitable choice may be a document printer, or a multifunction device which has document printing as one of its functions. A particularly suitable device would be a document printer adapted to record passages of sound on to mounted electronic storage devices for fixed attachment to printed documents. Such a printer is described in greater detail in European Patent Application Number 98305436.2 and in the International Patent Application entitled “Printed Image with Related Sound”, filed on the same day as the present application and claiming priority from the aforementioned European Patent Application.

The elements and structure of a clip recording device 10 in relation to recording of sound or other data on to the clip will be described further below.

The sound reproduction device 4 will now be described with reference to FIG. 6. Sound reproduction device 4 has a slot 24 adapted to receive connectors 15 of the electronic storage device 12. This allows access to the memory in the electronic storage device, and hence to the passage of sound, by the sound reproduction device 4. The reproduction device has user operable switches: in the embodiment shown in FIG. 6, there is a play/stop button 25 and a rewind button 26. Sound reproduction device 4 also comprises a loudspeaker. Further functional features normal in sound reproduction devices can also be provided: for example, a headphone/earpiece connection, a fast forward button and a volume control. Capability can also be provided for recording passages of sound on to the electronic storage device at the sound reproduction device 4. The passage of sound recorded on to the electronic storage device can then be modified or replaced at the sound reproduction device 4. The circuitry necessary for sound reproduction device 4 is discussed further below together with associated features of the audiotab.

As a key advantage of the clips is that they are adapted to fit conveniently in to a user's pattern of use of objects (in essence, they mimic items which a user already uses in everyday life), it is desirable that the sound reproduction device 4 does this also. It is therefore desirable that the sound reproduction device has an appropriate form factor, and is compatible with a user's existing behaviours. Such a sound reproduction device might be, for example, pen based, or might be incorporated as a part of another device used very regularly by a user, such as a palmtop computer.

In different arrangements, sound is provided from the sound capture device (such as dictation device 3, or possibly camera 1) directly to the sound reproduction device 4 (perhaps through a temporary storage on a different storage medium, or simply from a standard audio output), with the initial recording of sound on to the electronic storage device taking place at the sound reproduction device. Alternatively, this direct connection can be from the personal computer 2 to the sound reproduction device 4, with recording of the audiotab at the sound reproduction device 4. Sound can be processed in the personal computer 2 as indicated above with conventional software, and then sent to the sound reproduction device 4 for subsequent audiotab recording. Another variant that effectively combined features is for a sound capture device and sound reproduction device 4 to be the same object: this is a practical approach as sound recording and playback capability will typically be found together. This may be a particularly effective solution for a dictation device—especially suitable where the dictation device is also able to write passages of sound on to a clip, so that a user can dictate a memorandum and affix it to a document in effectively any situation with a minimum of inconvenience. Likewise, alternative arrangements employ personal computer 2, with appropriate peripheral circuitry, as sound reproduction device 4.

The circuitry of the electronic storage device and the sound reproduction device and clip recording device will now be described. Other circuitry, and programs, are essentially conventional and the person skilled in the art will be well aware of the choices that are available.

In respect of the clip recording device and sound reproduction device, what is described below is a single device adapted both to record passages of sound to clips (the function that a clip recording device must realise) and to play back passages of sound from clips (the function that a sound reproduction device must realise). It will be apparent that either a clip recording device or a sound reproduction device may be provided with both these functionalities—alternatively, each device may have only the function that it must realise, in which case it can readily be seen that features relating only to reading the passage of sound from the clip and reproducing it could be removed from the minimal clip recording device, whereas features relating to writing a passage of sound to the clip could be removed from the minimal sound reproduction device.

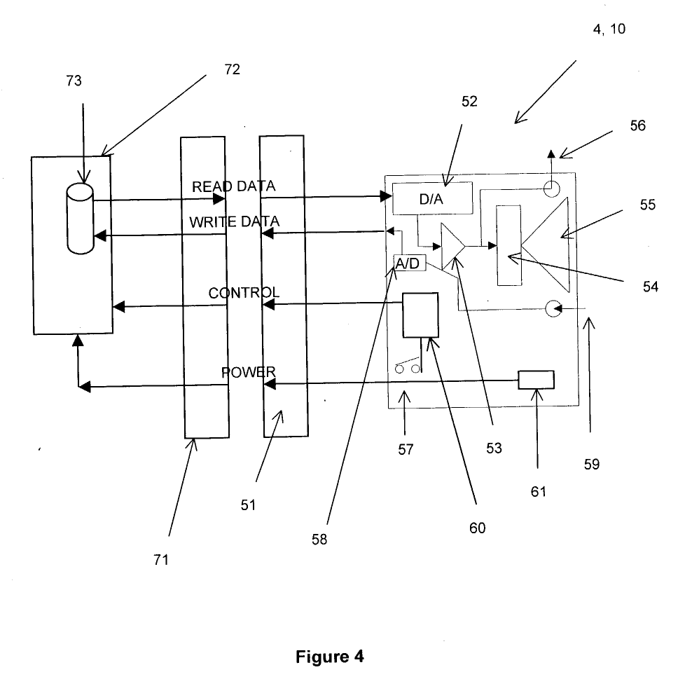

A digital solution for sound reproduction from sound stored on the electronic storage device is shown schematically in FIG. 4, supplementing the physical depiction in FIGS. 2, 3 and 3A. The electronic storage device 72 contains a non-volatile memory 73. In a preferred design choice, the electronic storage device is a CMOS device having an on-chip oscillator, a high density flash memory storage array, a serial interface, a write buffer and an address decoder. The bondout pitch of the die 216 (FIG. 2) is expanded by the tracks on the substrate 214 to provide a connector 215 (FIG. 2), shown schematically as connector 71 in FIG. 4, which can readily interface with an appropriately matched connector 51 of the sound reproduction device 4 (in this following description, the reader/writer device will be described as sound reproduction device 4—however, as is indicated above, the reader/writer device may equally be clip recording device 10). At this connector, a separate connection may be provided for every input and output required (signal, power) or alternatively these may be combined with appropriate conventional additional circuitry (for example, the signal may be provided by modulation of the power connection, in which case a modulator/demodulator circuit is also required). In the arrangement shown here, separate lines are shown for data reads from and data writes to the memory, with a separate line for control signals (from processor 60 of the sound reproduction device) and a separate line for powering of the electronic storage device (by battery 61 of the sound reproduction device). The arrangement shown in FIG. 4 shows direct access to the memory 73 by the sound reproduction device and direct playing of the sound recording device: an alternative solution is for appropriate means to be provided to first download some or all of the information stored in the memory 73 to a separate memory in the sound reproduction device 4 for fast access by the reproduction device. As the sound is recorded in digital form, it needs to pass through digital to analog converter 52 and normally an amplifier 53 and appropriate filtration and gain stages 54 before rendering as sound through loudspeaker 55 (or alternatively provided on headphone/line output 56). Functions such as play, stop, rewind and fast forward are provided by conventional circuitry from manual switches 57—such functions can either be hardwired or under the control of a processor 60 as is shown here. Recording at the sound reproduction device requires additionally microphone input 59, an analog to digital converter 58 and means to write to the memory 73—these elements are necessary for recording a chip (and thus must be provided by the clip recording device—though it is of course possible that the sound has been converted to digital form before it reaches clip recording device 10, and that all that is necessary is means to write to the memory 10 (in which case the clip recording device may be minimal—it needs only to be able to receive digital signals, and then transfer these into the memory of the electronic storage device in conventional manner). A power source for the sound reproduction device 4 is also needed, and is shown here as battery 61. No separate power source is required for the electronic storage device, as it does not need to draw power except when connected to the sound reproduction device, which provides the power. Sound compression and decompression can also be used to maximise storage efficiency: a separate stage for decompression of stored data can be provided before digital to analog conversion (and likewise after analog to digital conversion on recording) with conventional technology.

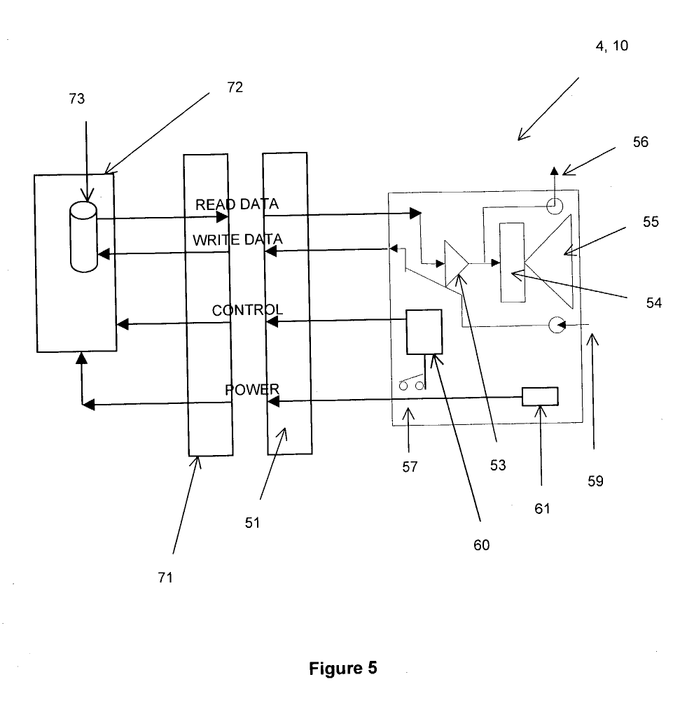

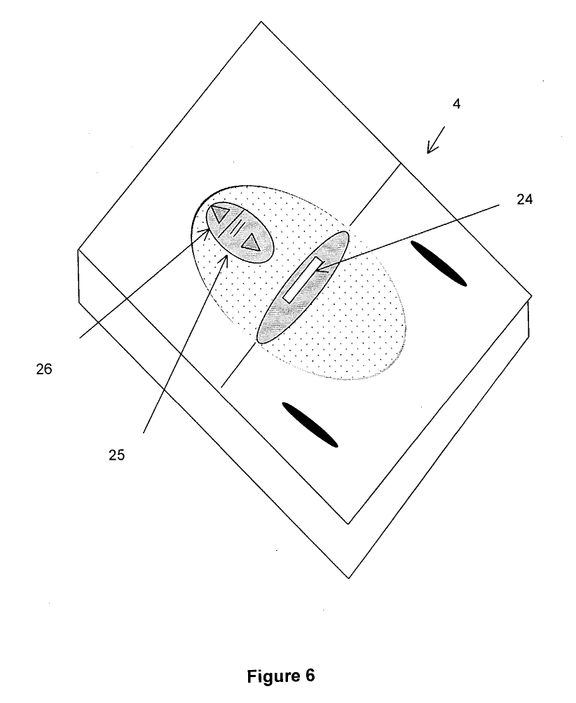

An analog sound storage solution is shown in FIG. 5. The arrangement of FIG. 5 is substantially similar to that of FIG. 4, and equivalent components are given the same reference numbers and are not described further here. In the analog case, no digital to analog converter 52 (or analog to digital converter on recording) is required: only a buffer (not shown) is required before amplifer 53. An appropriate analog storage technology is the ChipCorder technology of Information Storage Devices, Inc. (ISD), which provides a true quantised multilevel representation of the sample per cell. In this case the electronic storage device is preferably again a CMOS device with an on-chip oscillator and high density multilevel EEPROM (such as ChipCorder, discussed above) storage array; an antialiasing filter and a smoothing filter will also be required in the overall circuitry. Connection choices in supply of power and signals can be as for the digital case.

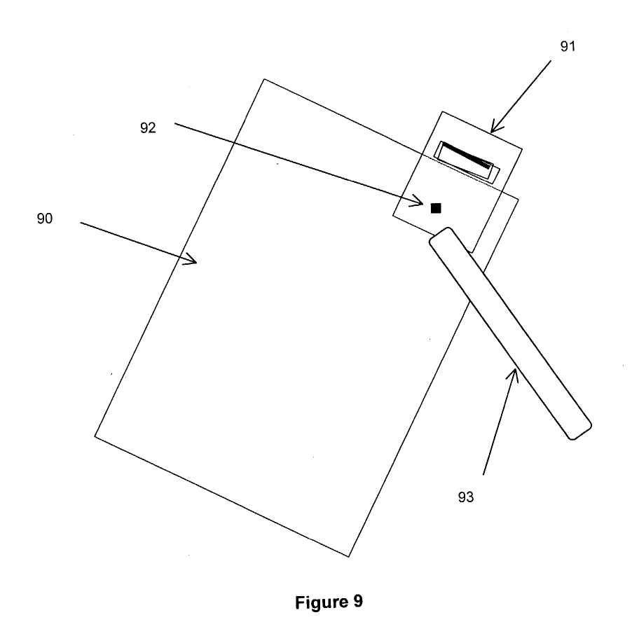

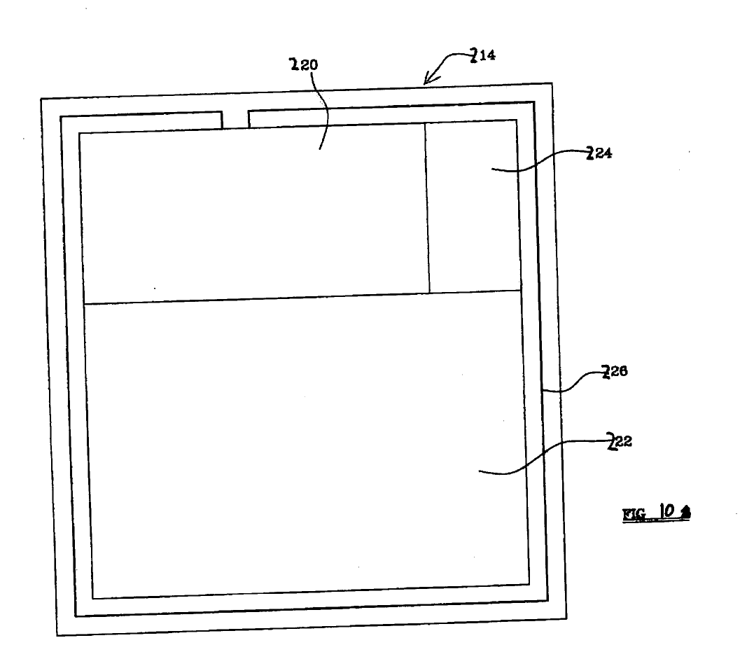

A further advantageous embodiment is shown in FIG. 9. In this case the electronic storage device 92 within the clip 91 is an inductively powered memory device (powered in the same was as for a passive Radio Frequency Identification (RFID) tag)—which can be read, or written to, by a reader 93 (here shown in a stylus form factor). The reader provides a radio frequency signal which is powerful enough to couple enough power into an antenna on the clip to power up the electronic storage device—this signal may be modulated with data to control or interact with the electronic storage device and in particular with data for writing to it. The electronic storage device is adapted to modulate reflection of power such to provide a data signal containing data written on the electronic storage device—this can be read by the reader. In the discussion below, this form of electronic storage device will be described as a memory tag.

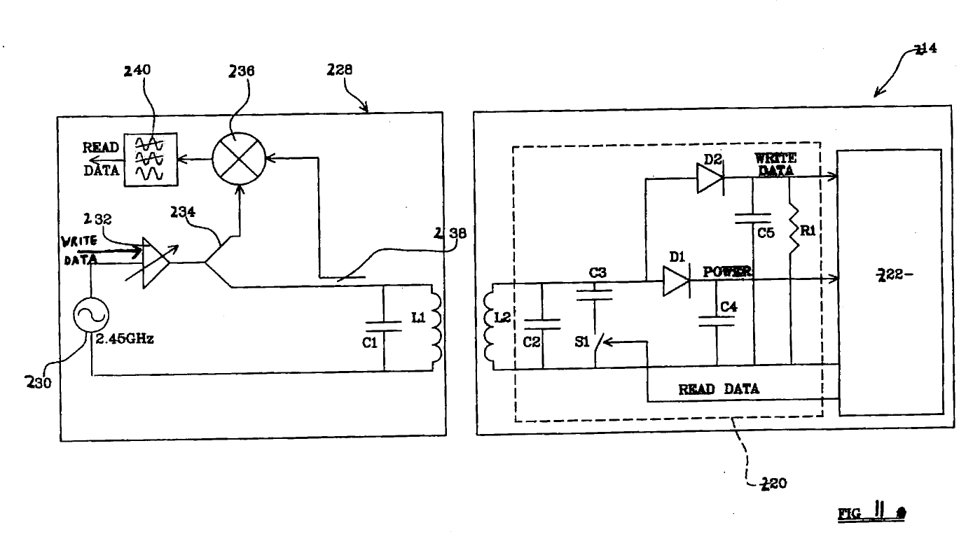

Referring now to FIG. 10, a schematic of a memory tag 214 is shown. The memory tag 214 is an RFID memory tag provided on a chip, and comprises an RFID transponder circuit 220, a memory 222, a power supply capacitor 224 and an antenna coil 226 having only a few turns e.g. five, or as in this case a single turn. The RFID transponder circuit 220 operates at 2.45 GHz, is of an area of approximately 0.5 mm², and will be described further below. The memory 222 provides 10Mbits of capacity of non-volatile memory and is of an area of approximately 1 mm², and uses FRAM (ferroelectric random access memory) or MRAM (magnetoresistive random access memory) or similar memory technology requiring low power. The memory tags 214 are of a substantially square shape in plan view with an external dimension D for their sides of around 1 mm.

Referring now to FIG. 11, the circuitry of a memory tag 214 and circuitry 228 of the read/write device 216—as before, both read and write are described and both functionalities may be found in sound recording device 4 or clip recording device 10, though only “read” is essential to the former and only “write” to the latter) are illustrated schematically, using conventional component identifications (C-capacitor, L-inductance, R-resistor, D-diode and S-switch). The RFID transponder circuit 220 of the memory tag 214 comprises a capacitor C2 which, in combination with the antenna coil L2(226), forms a resonant circuit with component values being chosen to tune the combination to approximately 2.45 GHz for inductive coupling with the read/write device 216. The portion of transponder circuit 220 responsible for power supply is diode D1 and capacitor C4(224), with diode D1 rectifying the alternating current generated by the inductive coupling and the capacitor C4 acts as a power supply storage. The portion of the transponder circuit 220 responsible for receiving transmitted data from the read/write device 216 is diode D2, capacitor C5 and resistor R1 which form a simple envelope detector; the data thus received is stored in memory 222. The portion of the transponder circuit 220 responsible for the reading of data from the memory 222 is the tuned circuit L2/C2 in combination with S1 and C3, switching C3 in and out of the circuit using S1 changes the resonance of tuned circuit L2/C2 resulting in phase modulation of the reflected power from the memory tag 214 to the read/write device 216.

The circuit 228 of the read/write device 216 comprises a signal generator 230 which generates a signal at the chosen frequency of 2.45 GHz. This signal passes via an amplitude modulator 232, where it is amplitude modulated with data (shown as WRITE DATA) to be written to the memory tag 214, and a splitter 234, to an antenna L1 and capacitor C1 which form a tuned circuit. The component values of L1 and C1 being chosen to tune it to 2.45 GHz, as for the tuned circuit in the memory tag 214, in order to maximise inductive coupling between the two circuits, and thus transmission of power and data to the memory tag 214.

The splitter 234 takes a part (as much as 50% of the power) of the amplitude modulated signal, for use as a reference signal, and passes it to a multiplier 236. The signal received from the memory tag 214, via the tuned circuit L1/C1 and divided from the outgoing signal by a coupler 238, is also passed to the multiplier 236. Thus the transmitted amplitude modulated signal and received signal are multiplied and then pass through a low pass filter 240 to provide a signal comprising the phase modulation from the memory tag 214 and thus indicative of the data read from the memory tag 214 (shown here as READ DATA). For a digital arrangement as shown here, this READ DATA signal will pass to a digital to analog converter to allow sound reproduction, and the circuitry from this point will be essentially similar to that shown in FIG. 4. The same applies to WRITE DATA—this data will be received from an analog to digital converter as in the FIG. 4 arrangement, and the circuitry upstream of this point will again be essentially that shown in the FIG. 4 arrangement.

One amplitude modulation format which may be used to apply the data to be transmitted to the 2.45 GHz signal is Amplitude Shift Keying (ASK) which only requires the simple envelope detector D2/C5 described in the circuit 220. However, other amplitude modulation formats may also be employed. Further alternatives are Frequency Shift Keying (FSK) and Phase Shift Keying (PSK) that provide near constant envelope modulation, that is without any significant amplitude modulation, however these options have more complex demodulation requirements and thus demand more complex circuitry in the memory tag 214.

With the apparatus of memory tag 214 and read/write device 216 described above power transfer of around 25% can be achieved with a distance of around 1.8 mm between the antennae L1 and L2, of the read/write device 216 and memory tag 214 respectively. This is sufficient to transfer enough power to the memory tag 214 for it to operate.

The memory tags 214 have an external dimension D of around 1 mm, as described above, and therefore the read/write device 216 can communicate with them over a relatively short range, in this example of approximately 2D. However, the distance over which the read/write device 16 and memory tag 214 will communicate effectively will clearly vary with the exact details of their construction.

The memory tags 214 will preferably have a data rate of 10Mbitss⁻¹, which is two orders of magnitude faster than is typical in prior art devices. Such a data rate would enable the read/write device 216 to be held over the memory tag for a very short period of time (“brush and go”) for the data to be read or written as appropriate. Although the memory tags 214 described above operate at 2.45 GHz it should be understood that memory tags operating at other frequencies may be used to implement the invention. Factors affacting the choice of operating frequency for the memory tags are: a) government regulations concerning radio frequency transmissions; b) adequate bandwidth (consistent with government regulations); c) frequency high enough to render the physical size of components in the memory tag small enough to keep the area of silicon required low (and hence the cost to manufacture low); d) frequency low enough to provide adequate performance when using low-cost high-volume CMOS technology to manufacture the memory tag.

The arrangements described provide for annotations such as passages of sound to be easily and effectively added to real world objects (such as paper documents and desktops) and to be consumed with similar ease by a user. The invention therefore generally provides a versatile way to provide electronic annotation to objects, particularly document, and in particular provides for passages of sound to be added to and consumed from real world objects in such a way that they provide a real enhancement to the modes of communication available to a user.

1. A sound storage device for annotating an arbitrary object with a passage of sound comprising:
an electronic storage device adapted to store information defining a passage of sound;
a body on which, or in which, the electronic storage device is arranged; and
an attachment mechanism to enable selective engagement between the body and an arbitrary object of a type suitable for engagement with the attachment mechanism;
the sound storage device having within it no means for playing back the passage of sound, but being adapted such that the information defining a passage of sound may be accessed from the device throughout the time of engagement between the body and such an arbitrary object by a sound reproduction device adapted to convert said information received from the electronic storage device into the passage of sound.

2. A sound storage device as claimed in claim 1 wherein the attachment mechanism is a spring clip.

3. A sound storage device as claimed in claim 2 wherein the type of arbitrary object suitable for engagement with the attachment mechanism is a paper document.

4. A sound storage device as claimed in claim 1 wherein the attachment mechanism is an adhesive surface, and the type of arbitrary object suitable for engagement with the attachment mechanism consists of objects with a surface to which the adhesive surface weakly adheres.

5. A sound storage device as claimed in claim 1 wherein the attachment mechanism is a magnetic element, and the type of arbitrary object suitable for engagement with the attachment mechanism consists of objects attracted to the magnetic element.

6. A sound storage device as claimed in claim 1, wherein the electronic storage device is adapted to store information other than that defining the passage of sound.

7. A sound storage device as claimed in claim 6, wherein said other information defines an image.

8. A sound storage device as claimed in claim 6, wherein said further information comprises information related to the recording of the passage of sound.

9. A sound storage device as claimed in claim 1, wherein the electronic storage device comprises an integrated circuit.

10. A sound storage device as claimed in claim 9, wherein the sound storage device further comprises electrical contacts for engagement with a further device to allow connection between the further device and the electronic storage device so that the further device may access a passage of sound recorded on the electronic storage device.

11. A sound storage device as claimed in claim 10, wherein the sound storage device is powered in use, and wherein the electrical contacts are adapted to provide a power input from the further device.

12. A sound storage device as claimed in claim 9, wherein the sound storage device comprises an antenna adapted to couple power into the sound storage device from wireless signals, and further comprising wireless transmitting circuitry such that data may be transmitted from the electronic storage device when the sound storage device is powered.

13. A sound storage device as claimed in claim 1, wherein the electronic storage device is adapted to be re-recordable.

14. A sound storage device for annotating an arbitrary object with a passage of sound comprising:
an electronic storage device adapted to store information defining a passage of sound;
an antenna adapted to couple power inductively into the sound storage device;
wireless transmitter circuitry adapted such that when powered, the sound storage device can wirelessly transmit data from the electronic storage device;
a body on which, or in which, the electronic storage device is arranged; and
an attachment mechanism to enable selective engagement between the body and an arbitrary object of a type suitable for engagement with the attachment mechanism;
the sound storage device having within it no means for playing back the passage of sound, but being adapted such that the information defining the passage of sound may be wirelessly transmitted from the sound storage device for receipt by a sound reproduction device adapted to convert said information received from the electronic storage device into the passage of sound throughout the time of engagement between the body and such an arbitrary object when the antenna couples sufficient power into the sound storage device.

15. A sound storage device as claimed in claim 14, further comprising wireless receiver circuitry adapted such that when powered, the sound storage device can wirelessly receive data and store such data in the electronic storage device.

16. A sound storage device as claimed in claim 14, wherein the sound storage device is further adapted to delete data stored in the electronic storage device for replacement by wirelessly received data.

17. A sound recording and playback system, comprising:
a sound storage device comprising an electronic storage device adapted to store information defining a passage of sound, a body on which, or in which, the electronic storage device is arranged, and an attachment mechanism to enable selective engagement between the body and an arbitrary object of a type suitable for engagement with the attachment mechanism, the sound storage device having within it no means for playing back the passage of sound, but being adapted such that the information defining the passage of sound may be accessed from the device throughout the time of engagement between the body and such an arbitrary object;
a sound recording device adapted to record a passage of sound on to the sound storage device; and
a sound reproduction device adapted to obtain the information defining the passage of sound from the sound storage device, to convert said information received from the electronic storage device into the passage of sound, and to reproduce the passage of sound.

18. A sound recording and playback system as claimed in claim 17, wherein the sound recording device and the sound reproduction device are the same device.

19. A method of temporarily annotating arbitrary objects with sound, comprising:
storing information defining a passage of sound in a sound storage device which comprises an electronic storage device but which does not comprise any means for playing back the passage of sound;
attaching the sound storage device to the arbitrary object such that information defining the passage of sound may be accessed through interaction with an appropriate sound reproduction device;
removing the sound storage device from the arbitrary object; and
attaching the sound storage device to a further arbitrary object such that information defined by a stored passage of sound may be played back by interaction with an appropriate sound reproduction device.

20. A method of temporarily annotating arbitrary objects with sound as claimed in claim 19, further comprising storing information defining a further passage of sound in the sound storage device, such that on attaching the sound storage device to the further arbitrary object the stored passage of sound which may be played back is the further passage of sound.

21. A method of annotating arbitrary objects and providing annotations to a user, comprising the steps of:
storing an annotation in a storage device which comprises an electronic storage device but which does not comprise any means for enabling the annotation to be directly perceived by a user, the storage device having an antenna to couple power inductively into the storage device, having a wireless transmitter circuit and having a wireless receiver circuit;
attaching the storage device to the arbitrary object such that the annotation may be transmitted from the storage device by the wireless transmitter circuit when the storage device is inductively powered through the antenna for receipt by apparatus adapted to provide the annotation for direct perception by the user; and
adding a further annotation to the storage device by coupling power inductively into the storage device through the antenna and transmitting the further annotation to the wireless receiver circuit for storage in the electronic storage device.

22. A method as claimed in claim 22, wherein the step of adding a further annotation further comprises removing the annotation already present.

23. A storage device for annotating an arbitrary object comprising:
an electronic storage device adapted to store an annotation;
an antenna adapted to couple power inductively into the storage device;
wireless transmitter and receiver circuitry adapted such that when powered, the storage device can wirelessly receive data for and transmit data from the electronic storage device;
a body on which, or in which, the electronic storage device is arranged; and
an attachment mechanism to enable selective engagement between the body and an arbitrary object of a type suitable for engagement with the attachment mechanism;
the storage device being adapted such throughout a time of engagement between the body and such an arbitrary object when the antenna couples sufficient power into the sound storage device, the annotation may be wirelessly transmitted from the storage device and a further annotation may be wirelessly received by the storage device for storage in the electronic storage device.

24. A sound storage device for annotating an arbitrary object with a passage of sound comprising:
an electronic storage device adapted to store information defining a passage of sound;
a body on which, or in which, the electronic storage device is arranged; and
an attachment mechanism to enable the body to be attached to an arbitrary object of a type suitable for use with the attachment mechanism and to be subsequently detached from the arbitrary object without damage to the sound storage device;
the sound storage device having within it no means for playing back the passage of sound, but being adapted such that the information defining the passage of sound may be accessed from the device throughout the time of engagement between the body and such an arbitrary object by a sound reproduction device adapted to convert said information received from the electronic storage device into the passage of sound.

25. A sound storage device for annotating a physical document with a passage of sound comprising:
a re-recordable electronic storage device adapted to store information defining a passage of sound;
a body on which, or in which, the electronic storage device is arranged; and
a spring clip to enable selective engagement between the body and the physical document and subsequent disengagement without damage to the sound storage device;
the sound storage device having within it no means for playing back the passage of sound, but being adapted such that the information defining the passage of sound may be accessed from the device throughout the time of engagement between the body and such an arbitrary object by a sound reproduction device adapted to convert said information received from the electronic storage device into the passage of sound.

26. A sound storage device for annotating a surface with a passage of sound comprising:
a re-recordable electronic storage device adapted to store information defining a passage of sound;
a body on which, or in which, the electronic storage device is arranged; and
a weakly adhesive surface on the body to enable selective engagement between the body and the surface and subsequent disengagement without damage to the sound storage device;
the sound storage device having within it no means for playing back the passage of sound, but being adapted such that the information defining the passage of sound may be accessed from the device throughout the time of engagement between the body and such an arbitrary object by a sound reproduction device adapted to convert said information received from the electronic storage device into the passage of sound.

27. A sound storage device for annotating a magnetic object with a passage of sound comprising:
a re-recordable electronic storage device adapted to store information defining a passage of sound;
a body on which, or in which, the electronic storage device is arranged; and
a permanent magnet to enable selective engagement between the body and the magnetic object and subsequent disengagement without damage to the sound storage device;
the sound storage device having within it no means for playing back the passage of sound, but being adapted such that the information defining the passage of sound may be accessed from the device throughout the time of engagement between the body and such an arbitrary object by a sound reproduction device adapted to convert said information received from the electronic storage device into the passage of sound.

28. A storage device for annotating an arbitrary object comprising:
an electronic storage device adapted to store an annotation;
electrical contacts for engagement with a further device to allow connection between the further device and the electronic storage device so that the further device may power the storage device and that when powered, the storage device can receive data for the electronic storage device from the further device and transmit data to the further device from the electronic storage device;
a body on which, or in which, the electronic storage device is arranged; and
an attachment mechanism to enable selective engagement between the body and an arbitrary object of a type suitable for engagement with the attachment mechanism;
the storage device being adapted such throughout a time of engagement between the body and such an arbitrary object when the electrical contacts are brought into contact with a further device, the annotation may be transmitted from the storage device to the further device and a further annotation may be received by the storage device from the further device for storage in the electronic storage device.

29. A method of annotating arbitrary objects and providing annotations to a user, comprising the steps of:
storing an annotation in a storage device which comprises an electronic storage device but which does not comprise any means for enabling the annotation to be directly perceived by a user, the storage device having electrical contacts for engagement with a further device to allow connection between the further device and the electronic storage device so that the further device may power the storage device and that when powered, the storage device can receive data for the electronic storage device from the further device and transmit data to the further device from the electronic storage device;
attaching the storage device to the arbitrary object such that the electrical contacts are engageable with the furthe device;
enagaging the electrical contacts with the further device and reading the annotation from the electronic storage device into the further device, wherein the further device is adapted to provide the annotation in a form susceptible of direct perception by the user; and
engaging the electrical contacts with the or another further device and adding a further annotation to the storage device by transmitting the further annotation from the or another further device to the storage device for storage in the electronic storage device.
